(19) United States
(12) Patent Application Publication
(10) Pub. No.: US 2019/0072777 A1
(43) Pub. Date: Mar. 7, 2019

(54) CONTROL APPARATUS FOR OPTICAL APPARATUS, OPTICAL APPARATUS, CONTROL METHOD FOR THE OPTICAL APPARATUS, AND STORAGE MEDIUM

(71) Applicant: CANON KABUSHIKI KAISHA, Tokyo (JP)

(72) Inventor: Koji Okada, Utsunomiya-shi (JP)

(21) Appl. No.: 16/113,434

(22) Filed: Aug. 27, 2018

(30) Foreign Application Priority Data
Sep. 1, 2017 (JP) 2017-168750

(51) Int. Cl. G02B 27/64

(52) U.S. Cl. CPC G02B 27/646; H04N 5/23264

(57) ABSTRACT

A control apparatus for an optical apparatus includes a correction value acquiring unit configured to acquire a correction value used to correct a first vibration detection signal output from a vibration detecting unit configured to detect a vibration of the optical apparatus, and a processing unit configured to store in a memory a plurality of correction values on different acquisition conditions used to acquire the correction values in such a manner that each of the plurality of correction values is correlated with the acquisition condition on which the each of the plurality of correction values is acquired.

### BACKGROUND OF THE INVENTION

### Field of the Invention

The present invention relates to an antivibration (image stabilization) control in an optical apparatus.

### Description of the Related Art

An antivibration system reduces image blurs due to a manual vibration (shake) or the like (referred to as a “camera vibration” hereinafter) in an optical apparatus, such as a camera and an interchangeable lens, and often uses a gyro sensor that detects an angular velocity so as to detect the camera vibration. However, the output (vibration detection signal) from the gyro sensor contains an offset component due to temperature changes, variations over time, or the like. That is, under different environments, offset components are different and thus even when the gyro sensor outputs the same output, a true value of the angular velocity may differ. Since this offset component affects the antivibration performance, it is necessary to remove the offset component from the vibration detection signal.

Japanese Patent No. (“JP”) 4666787 discloses a method of detecting an output of a gyro sensor at a predetermined timing as an offset component whenever an optical apparatus is powered on and of subtracting the output from the subsequent vibration detection signal from the gyro sensor. JP 4924321 discloses a method of calculating (calibrating) an offset component in charging of an optical apparatus.

However, the method disclosed in JP 4666787 detects the offset component even when the vibration detection signal from the gyro sensor fluctuates due to the camera vibration, and is likely to erroneously detect the offset component. It is thus difficult to accurately remove the offset component from the vibration detection signal. Further, the method disclosed in JP 4924321 may not correctly remove the offset component in use from the vibration detection signal because the environmental condition, such as the temperature, is different between when the optical apparatus is charged and when the optical apparatus is used.

### SUMMARY OF THE INVENTION

The present invention provides a control apparatus for an optical apparatus, an optical apparatus having the same, which can more correctly obtain an offset component when the optical apparatus is used.

A control apparatus for an optical apparatus according to one aspect of the present invention includes a correction value acquiring unit configured to acquire a correction value used to correct a first vibration detection signal output from a vibration detecting unit (shake detecting unit) configured to detect a vibration of the optical apparatus, and a processing unit configured to store in a memory a plurality of correction values on different acquisition conditions used to acquire the correction values in such a manner that each of the plurality of correction values is correlated with the acquisition condition on which the each of the plurality of correction values is acquired.

An optical apparatus that includes the above control apparatus, a control method of the optical apparatus, and a storage medium that stores the control method also constitute other aspects of the present invention.

Further features of the present invention will become apparent from the following description of exemplary embodiments with reference to the attached drawings.

### BRIEF DESCRIPTION OF THE DRAWINGS

FIG. 1 is a block diagram of a configuration of a lens unit having a microcomputer according to a first embodiment of the present invention.

FIG. 2 is a flowchart of offset component removal processing according to the first embodiment.

FIG. 3 illustrates a data table stored in a memory in the first embodiment.

FIG. 4 is a flowchart of new offset component acquisition processing according to the first embodiment.

FIG. 5 is a block diagram of configurations of a camera body having a microcomputer and a lens unit according to a second embodiment of the present invention.

FIG. 6 is a flowchart of offset component removal processing in the second embodiment.

FIGS. 7A-7C illustrate a data table stored in a memory in the second embodiment.

FIG. 8 is a flowchart of new offset component acquisition processing according to the second embodiment.

### DESCRIPTION OF THE EMBODIMENTS

Referring now to the accompanying drawings, a description will be given of embodiments of the present invention.

### First Embodiment

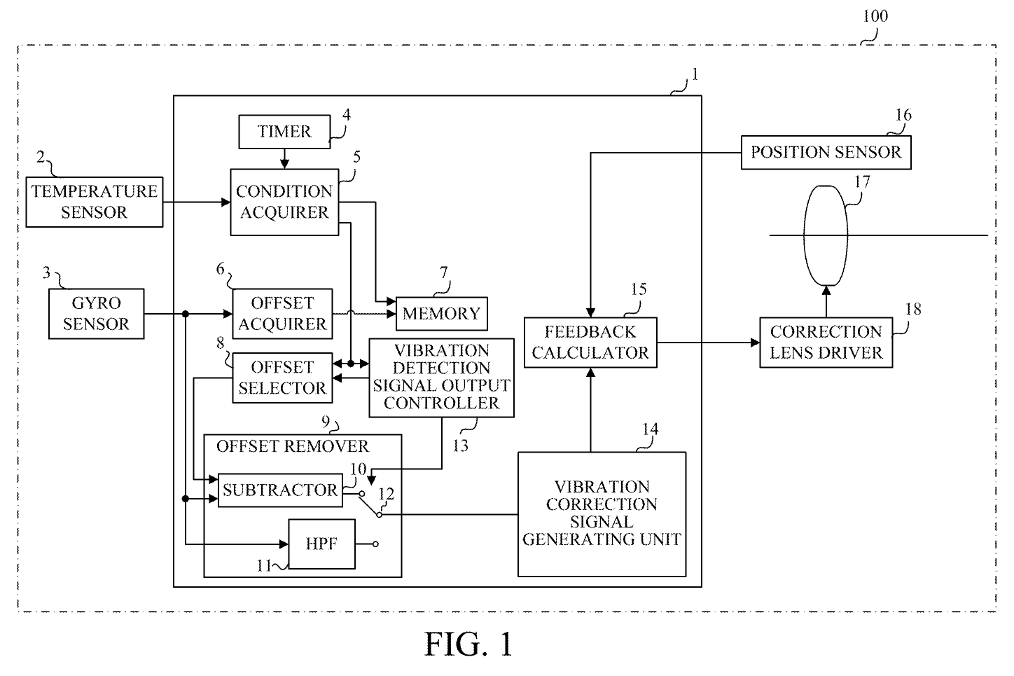

FIG. 1 shows a configuration of an interchangeable lens (referred to as a “lens unit” hereinafter) 100 as an optical apparatus having a microcomputer 1 as a control apparatus for an optical apparatus according to a first embodiment of the present invention. The lens unit 100 is detachably attached to, receives a power supply from, and communicates with an unillustrated camera body.

The lens unit 100 has an imaging optical system that includes a correction lens (antivibration element or image stabilizer) 17, another lens such as an unillustrated focus lens, and an unillustrated diaphragm (aperture stop). The correction lens 17 is configured to shift in a yaw direction and a pitch direction orthogonal to the optical axis of the imaging optical system and orthogonal to each other, and reduces (corrects) an image blur due to a camera vibration.

A microcomputer 1 controls the entire operation of the lens unit 100, such as a focusing operation and a diaphragm operation, and includes the following processing of removing an offset component from a vibration detection signal and processing of generating a vibration correction signal. The microcomputer 1 also functions as a processing unit.

A gyro sensor 3 as a vibration detecting unit detects angular velocities in the yaw direction and the pitch direction that are orthogonal to the optical axis and each other, and outputs a yaw vibration detection signal and a pitch vibration detection signal as first vibration detection signals (angular velocity signals) that represent angular velocities in these directions. An offset acquirer (correction value acquiring unit) 6 detects a yaw offset component and a pitch offset component that are DC components contained in the yaw vibration detection signal and the pitch vibration detection signal from the gyro sensor 3, respectively, and acquires a yaw offset value and a pitch offset value representing the offset components.

The following description will collectively refer to the yaw vibration detection signal and the pitch vibration detection signal as a vibration detection signal, and the yaw offset component and the pitch offset component as an offset component. Further, the yaw offset value and the pitch offset value will be collectively referred to as an offset value (correction value).

The microcomputer 1 includes a timer 4, a condition acquirer 5, an offset acquirer 6, a memory 7, an offset selector 8, a switch 12, a vibration detection signal output controller 13, an offset remover 9, a vibration correction signal generating unit 14, and a feedback calculator 15.

The condition acquirer 5 acquires the current temperature from a temperature sensor (detector) 2 and acquires the current date (which may include the time) from the timer 4. The microcomputer 1 correlates information indicating an acquisition condition including at least the date and temperature obtained from the condition acquirer 5 (referred to as “acquisition condition information” hereinafter) and an offset value obtained from the offset acquirer 6 with one another and stores it in the memory 7 as a pair of datasets. The memory 7 includes a nonvolatile memory that retains the stored content even when the lens unit 100 is powered off.

The vibration detection signal output controller 13 acquires the current date and temperature from the condition acquirer 5 and collates it with the date and temperature indicated by the acquisition condition information on a plurality of datasets previously stored in the memory 7. The plurality of datasets indicate offset values corresponding to different acquisition conditions (at least one of the date and the temperature). The vibration detection signal output controller 13 reads, as a currently available candidate data, at least one dataset whose date and temperature fall within a predetermined range about the current date and temperature among the plurality of datasets. Furthermore, the offset selector 8 switches the switch 12 as described later.

The offset selector 8 selects, as a use (or service) dataset, a dataset whose date and temperature are closest to the current date and temperature among the candidate datasets read out by the vibration detection signal output controller 13, and acquires the offset value contained in the use dataset as a use (or service) offset value. The offset remover 9 acquires a vibration detection signal from the gyro sensor 3 and the use offset value selected from the offset selector 8, and inputs them into a subtractor 10. The subtractor 10 removes an offset component corresponding to the use offset value from the input vibration detection signal and outputs (generates) an offset removed vibration detection signal as the second vibration detection signal.

The offset remover 9 also inputs the vibration detection signal acquired from the gyro sensor 3 to a high-pass filter (HPF) 11. The high-pass filter 11 outputs, from the input vibration detection signal, a high-pass vibration detection signal in which low-frequency components lower than a cutoff frequency are filtered.

When the candidate dataset exists, the vibration detection signal output controller 13 switches the switch 12 to the subtractor 10 side and inputs the offset removed vibration detection signal to a vibration correction signal generating unit 14. On the other hand, when no candidate dataset exists, the switch 12 is switched to the high-pass filter 11 side to input the low-cut vibration detection signal into the vibration correction signal generating unit 14. The low-cut vibration detection signal is a vibration detection signal in which the offset component as a low frequency component is simply reduced. The vibration detection signal output controller 13, the offset remover 9 and the offset selector 8 constitute a signal generating unit.

The vibration correction signal generating unit 14 uses the offset removed vibration detection signal from the subtractor 10 or the low-cut vibration detection signal from the high-pass filter 11 to generate (calculate) a vibration correction signal representing a target position of the correction lens 17. Although unillustrated, the vibration correction signal generating unit 14 includes an integrator that converts the offset removed or low-cut vibration detection signal representing the angular velocity into a vibration correction signal representing an angular displacement, a phase compensator that adjusts the phase of the vibration correction signal, and a gain controller that controls the magnitude (gain) of the vibration correction signal.

A feedback calculator 15 calculates a difference between a detection position indicated by the output signal from the position sensor 16 that detects a shift position of the correction lens 17 and the target position indicated by the vibration correction signal generated by the vibration correction signal generating unit 14, generates a shift drive signal corresponding to the difference, and outputs the result to a correction lens driver 18. Thereby, the antivibration control is achieved. The vibration correction signal generating unit 14 and the feedback computing unit 15 constitute an antivibration (image stabilization) controller.

The correction lens driver 18 shifts the correction lens 17 in accordance with the shift drive signal from the feedback calculator 15 (or performs the antivibration operation under the antivibration control).

This embodiment selects whether to use the offset removed vibration detection signal from the subtractor 10 or the low-cut vibration detection signal from the high-pass filter 11 so as to generate the vibration correction signal. However, it may be selected whether to input the vibration detection signal from the gyro sensor 3 to the subtractor 10 or to the high-pass filter 11.

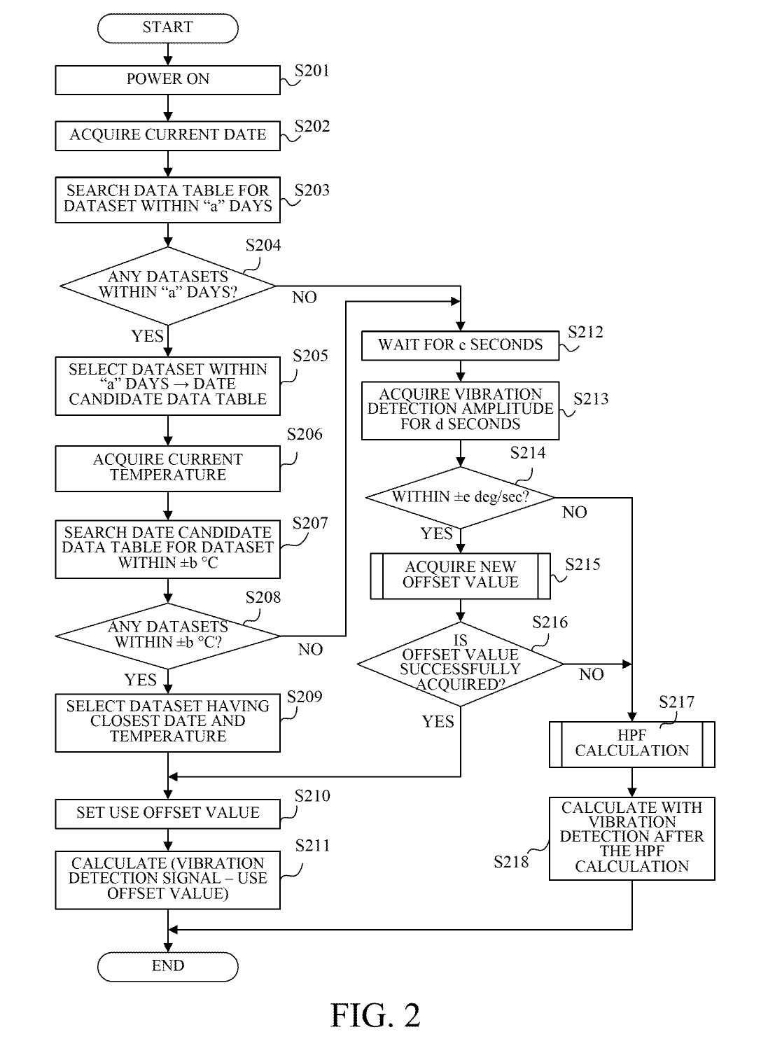

A flowchart in FIG. 2 illustrates processing of removing the offset component from the vibration detection signal according to this embodiment. The microcomputer 1 executes this processing in accordance with a computer program (or a control program for the optical apparatus).

When the camera body is powered on in the step S201 and the power is supplied to the lens unit 100, the condition acquirer 5 in the microcomputer 1 acquires the current date from the timer 4 in the step S202. Then, the flow moves to the step S203.

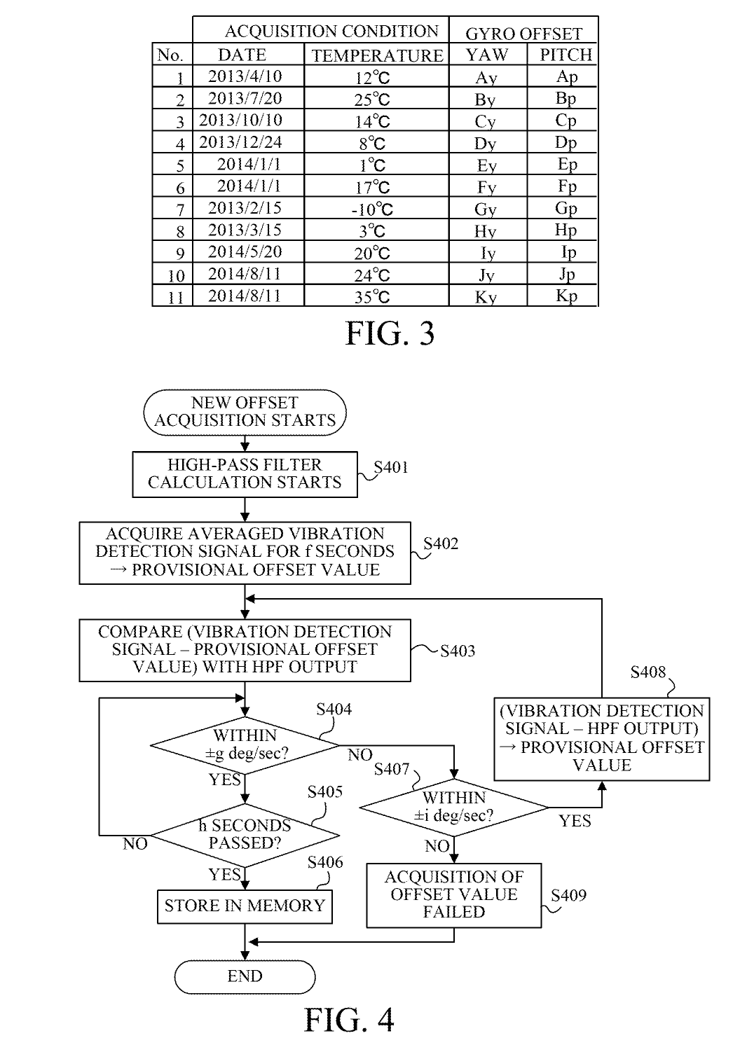

In the step S203, the vibration detection signal output controller 13 searches the data table containing a plurality of datasets stored in the memory 7, for a dataset that contains an offset value acquired within “a” days or a predetermined range from the current date. FIG. 3 illustrates a data table example stored in the memory 7. In the following description, an offset value acquired within “a” days from the current date will be referred to as a date candidate offset value (candidate correction value), and a dataset that contains the date evaluation candidate offset value will be referred to as a date candidate dataset.

Next, in the step S204, the vibration detection signal output controller 13 determines whether at least one pair of date candidate datasets exist. If so, the flow proceeds to the step S205, and if not, the flow proceeds to the step S212.

In the step S205, the vibration detection signal output controller 13 reads out all date candidate datasets, and prepares a date candidate data table that contains them.

Next, in the step S206, the condition acquirer 5 acquires the current temperature from the temperature sensor 2. Then, in the step S207, the vibration detection signal output controller 13 searches the date candidate data table generated in the step S205 for a temperature candidate dataset that contains a temperature candidate offset value obtained at a temperature within ±b ° C. or a predetermined range from the current temperature.

Next, in the step S208, the vibration detection signal output controller 13 determines whether or not there are at least one pair of temperature candidate datasets. If they exist, the flow proceeds to the step S209, otherwise the flow proceeds to the step S212. A dataset that is a date candidate dataset and also a temperature candidate dataset will be hereinafter referred to as a date temperature candidate dataset and an offset value contained in this date temperature candidate dataset will be referred to as a date temperature candidate offset value.

Next, in the step S209, the offset selector 8 selects, as the use dataset, a dataset acquired at the date or temperature closest to the current date or temperature from the date temperature candidate dataset. This embodiment sets the most important parameter to the temperature. Therefore, when there are two datasets, or the date closest to the date and the dataset closest to the temperature, the offset selector 8 selects the latter dataset as the use dataset. The most important parameter may be set to the date according to the characteristic of the gyro sensor 3.

Then, in the step S210, the offset remover 9 sets an offset value (or offset component) contained in the selected use dataset to an offset value (use correction value) used by the subtractor 10 for a subtraction from the vibration detection signal from the gyro sensor 3.

In the step S211, the vibration detection signal output controller 13 sets the switch 12 to the subtractor 10 side. Thereby, the offset removed vibration detection signal as a result of subtraction in the subtractor 10 of the use offset value from the vibration detection signal from the gyro sensor 3 is output to the vibration correction signal generating unit 14 and used to generate the vibration correction signal.

On the other hand, if there is no date candidate or temperature candidate dataset (or no usable offset value exists) in the step S204 or step S208, the flow proceeds to the step S212.

In the step S212, the microcomputer 1 waits for c seconds until it is ready to newly obtain an offset value. A period of the c seconds corresponds, for example, to a time period for stabilizing a stable output of the gyro sensor 3 after the power turns on, or a time period for stabilizing a manual vibration of the user caused by the power-on operation.

Next, in the step S213, the microcomputer 1 serves as a determiner, and samples the vibration detection signal outputted from the gyro sensor 3 for d seconds to obtain an amplitude of the vibration detection signal per unit time therebetween.

In the step S214, the microcomputer 1 determines whether or not the amplitude of the vibration detection signal obtained in the step S213 falls within ±e [deg/sec] or within a predetermined amplitude range. When it falls within ±e [deg/sec] or when it is determined that there is no significant camera vibration, the microcomputer 1 proceeds to the step S215 and acquires a new offset value through the offset acquirer 6.

In the step S216, the microcomputer 1 determines whether the new offset value has been successfully acquired in the step S215. If so, the flow proceeds to the step S210 and the new offset value is set to the use offset value. This new offset value is added as a new dataset to the memory 7 with the (current) date and temperature at which it was acquired.

On the other hand, if it is determined in the step S214 that the amplitude of the vibration detection signal does not fall within ±e [deg/sec] or when it is determined that there is a significant camera vibration, and where the acquisition of the new offset value has failed in the step S216, the microcomputer 1 proceeds to the step S217.

In the step S217, the offset remover 9 inputs the vibration detection signal from the gyro sensor 3 to the high-pass filter 11 or performs a high-pass filter calculation for the vibration detection signal.

In the step S218, the vibration detection signal output controller 13 sets the switch 12 to the high-pass filter 11 side. Thereby, the low-cut vibration detection signal having the offset component reduced after passing through the high-pass filter 11 is output to the vibration correction signal generating unit 14 and used to generate the vibration correction signal.

The high-pass filter 11 ideally removes only the offset component, but if the cutoff frequency is reduced down to the vicinity of DC (such as 0.01 Hz), the time constant will remarkably increase and it takes a long time to obtain a stable output. However, the excessively high cutoff frequency cannot satisfactorily reduce the image blur due to the low-frequency camera vibration. It is therefore necessary to set a cutoff frequency (such as 0.1 Hz) that reconciles the antivibration performance and the time constant with each other.

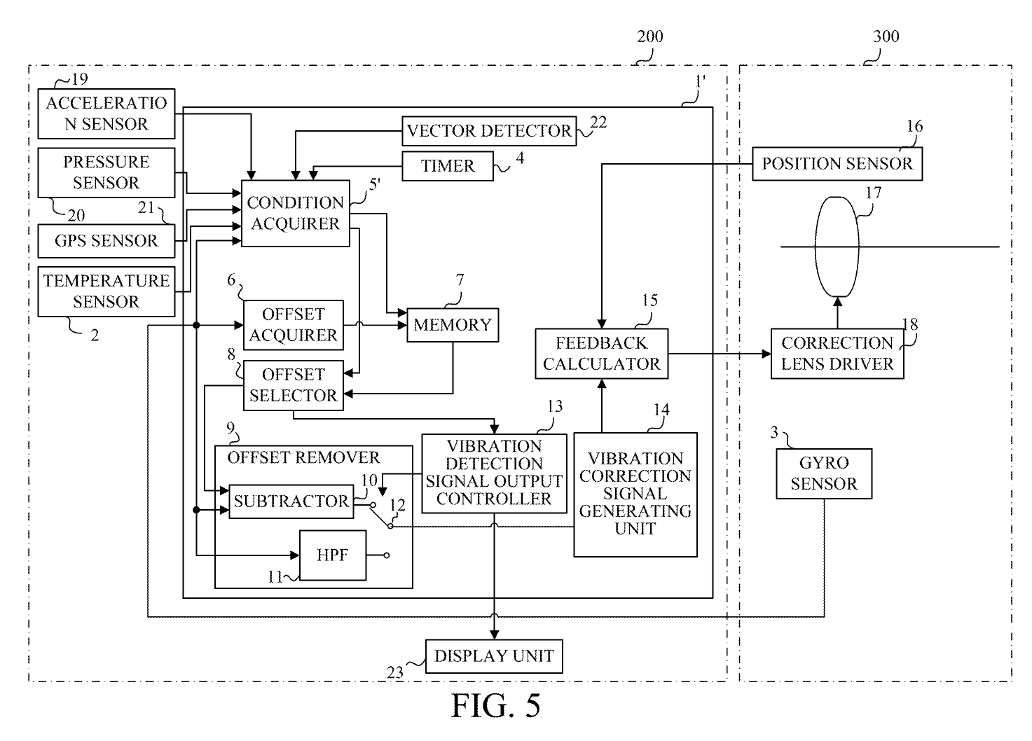

A flowchart in FIG. 4 illustrates processing of acquiring a new offset value in the step S215 in FIG. 2. In the step S401, the offset acquirer 6 starts a high-pass filter calculation for obtaining an offset value. The high-pass filter for this calculation is different from the high-pass filter 11 used for the step S217.

Next, in the step S402, the offset acquirer 6 acquires the vibration detection signal from the gyro sensor 3 for f seconds, averages it, calculates and temporarily stores a provisional offset value.

Next, in the step S403, the microcomputer 1 compares the provisional offset removed vibration detection signal as a value obtained by subtracting the provisional offset value from the vibration detection signal from the gyro sensor 3, with the new low-cut vibration detection signal as the high-pass filter calculation result started in step S401.

In the step S404, the microcomputer 1 determines whether or not a difference between the provisional offset removal vibration detection signal and the new low-cut vibration detection signal falls within ±g [deg/sec] (or within the predetermined amplitude range). When the difference falls within ±g [deg/sec], the microcomputer 1 proceeds to the step S405 and determines whether or not a period of h seconds (predetermined time) or longer have passed in that state. If h seconds or longer have passed while the difference falls within ±g [deg/sec], the microcomputer 1 proceeds to the step S406.

In the step S406, the microcomputer 1 correlates the date and the temperature acquired by the condition acquirer 5 and the “new offset value” that is the provisional offset value acquired this time with each other and stores them as one pair of datasets in the memory 7.

On the other hand, if h seconds or longer have not passed while the difference falls within ±g [deg/sec] in the step S404, the microcomputer 1 returns to the step S404, and wait for h seconds to pass in a state where the difference is ±g [deg/sec].

If the difference does not fall within ±g [deg/sec] in the step S404, the microcomputer 1 proceeds to the step S407 and determines whether the difference falls within ±i [deg/sec] (within the predetermined amplitude range). Herein, i represents an angular velocity higher than g. If the difference does not fall within ±i [deg/sec], the microcomputer 1 proceeds to the step S409 and does not store the offset value in the memory 7 as having failed to acquire the offset value. This case represents a large camera vibration in acquiring the new offset component, which is unsuitable for obtaining the offset component. When the difference falls within ±i [deg/sec], the microcomputer 1 proceeds to the step S408 to temporarily store the value obtained by subtracting the new low-cut detection signal from the vibration detection signal as a new provisional offset value, and then returns to the step S403.

This embodiment uses both the date and the temperature as the acquisition condition of the offset value, but may set only one of them to the acquisition condition depending on the characteristic of the gyro sensor (for example, in case of a few variations over time or small temperature change influence).

This embodiment selects, as the use offset value, an offset value corresponding to an acquisition condition that is as close as possible to the detection condition of the current vibration detection signal (in use) among the plurality of offset values that are previously stored in the memory 7 and have different acquisition conditions from each other. Thereby, the antivibration control accuracy can improve.

### Second Embodiment

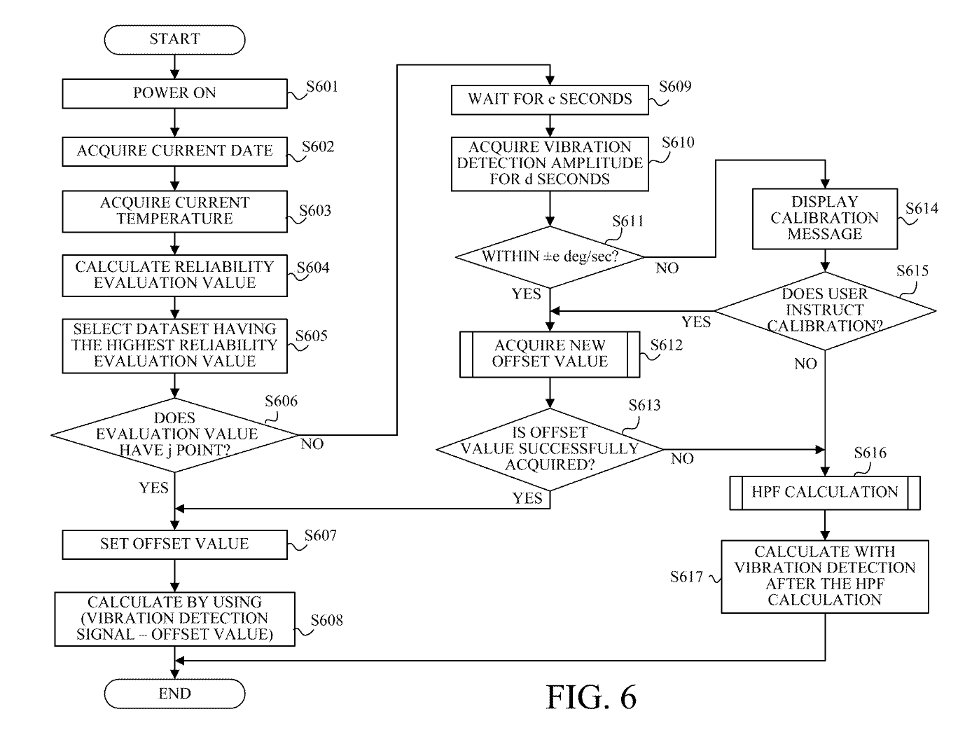

Referring now to FIG. 5, a description will be given of a configuration of a camera body (imaging apparatus) 200 as an optical apparatus having the microcomputer 1 as a control apparatus for an optical apparatus according to a second embodiment of the present invention. Those elements in FIG. 5, which are corresponding elements in the first embodiment, will be designated by the same reference numerals. A lens unit 300 is detachably attached to the camera body 200, and includes an imaging optical system that has the correction lens 17, the correction lens driver 18, the position sensor 16, and the gyro sensor 3. The lens unit 300 receives the power supply from and communicates with the camera body 200.

The camera body 200 includes a microcomputer 1′, a temperature sensor 2, an acceleration sensor 19, a pressure sensor 20, and a GPS sensor 21. The microcomputer 1′ is different from the microcomputer 1 in the first embodiment in that it includes a vector detector 22. In addition, a condition acquirer 5′ in the microcomputer 1′ receives outputs from the temperature sensor 2, the acceleration sensor 19, the pressure sensor 20, the GPS sensor 21, and the gyro sensor 3 in the lens unit 300.

The condition acquirer 5′ acquires the orientation of the camera body 200 by using the output of the acceleration sensor 19 in addition to the date and temperature described in the first embodiment as the acquisition condition of the offset value, and obtains an altitude by using the output from the pressure sensor 20. Further, the condition acquirer 5′ acquires the location (position) based on the output of the GPS sensor 21 as the acquisition condition of the offset value, and obtains a camera vibration amount from the motion vectors detected by the vector detector 22. This embodiment stores a plurality of datasets each containing the acquisition condition of the offset value, such as a date, temperature, and other conditions (orientation, altitude, location, and camera vibration amount), and an offset value correlated thereto in the memory 7. The plurality of datasets have different acquisition conditions (and hence different offset values).

A display unit 23 displays (outputs) a message as user oriented information that prompts the user to calibrate (reacquire) the offset value. The user who saw this message inputs an instruction to reacquire the offset value to the microcomputer 1′, and the offset acquirer 6 having received the instruction obtains the offset value again. An audio message may be output through a speaker.

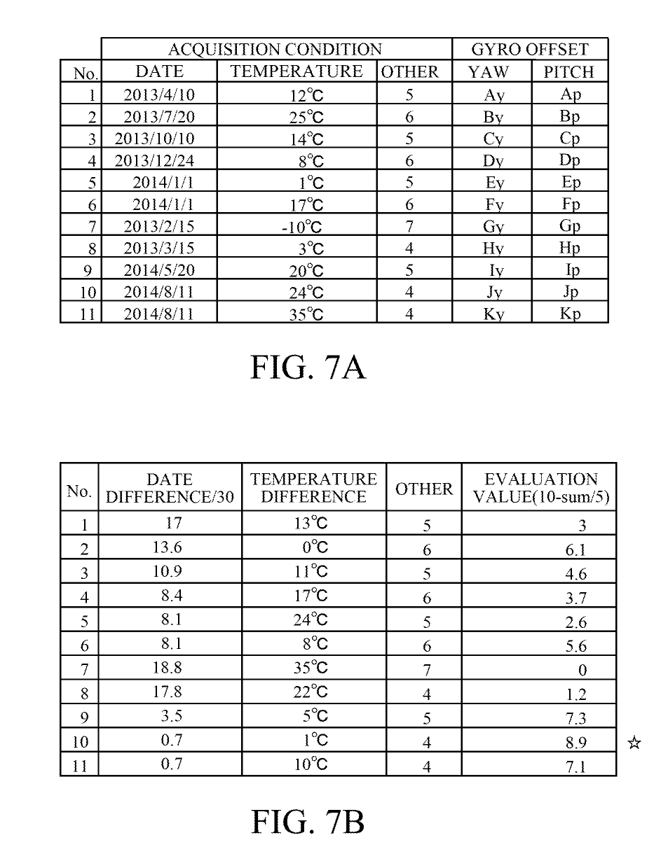

The flowchart in FIG. 6 illustrates processing of removing the offset component from the vibration detection signal according to this embodiment. The microcomputer 1′ executes this processing in accordance with a computer program (control program).

When the camera body 200 is powered on in the step S601, the condition acquirer 5′ in the microcomputer 1′ acquires the current date from the timer 4 in the step S602. Next, in the step S603, the condition acquirer 5′ acquires the current temperature from the temperature sensor 2.

Next, in the step S604, the offset selector 8 selects an evaluation value (referred to as a “reliability evaluation value” hereinafter) indicating the reliability of the offset value based on the current date and temperature and a data table containing a plurality of datasets stored in the memory 7.

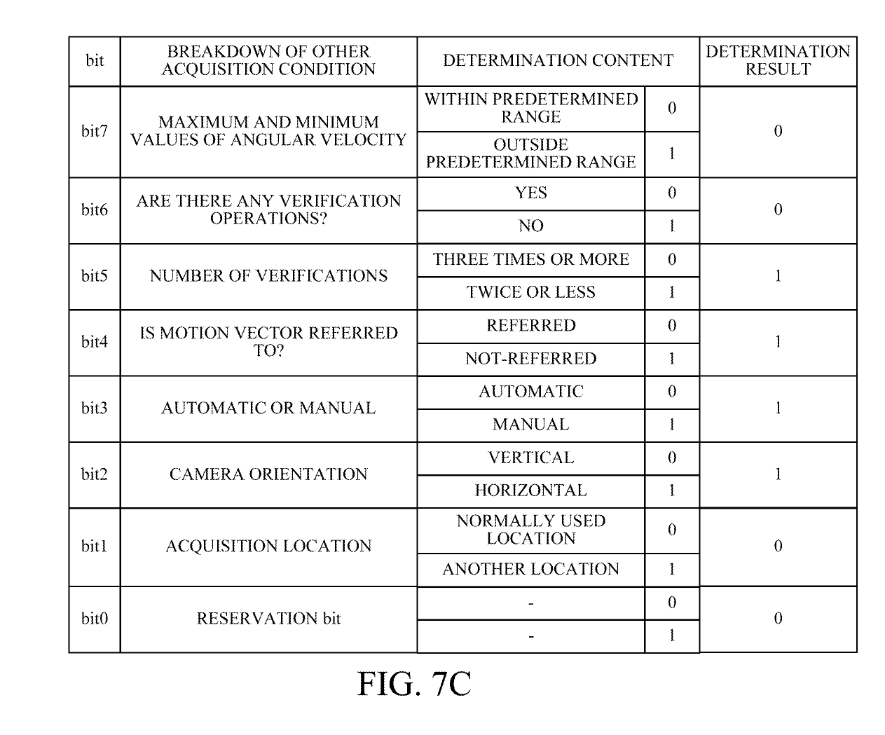

7A shows an illustrative data table stored in the memory 7. FIG. 7B shows the reliability evaluation value calculated by the following equation. It is now assumed in the calculation that the current date is Sep. 1, 2014 and the current temperature is 25° C. FIG. 7C shows a breakdown of other acquisition conditions and the evaluation examples (determination content and result). FIG. 7C will be described in detail later.

EVALUATION VALUE=10−(DATE DIFFERENCE/30+TEMPERATURE DIFFERENCE+OTHER ACQUISITION CONDITIONS)/5 (EXPRESSION 1)

DATE DIFFERENCE=CURRENT DATE−DATASET ACQUISITION DATE (EXPRESSION 2)

TEMPERATURE DIFFERENCE=CURRENT TEMPERATURE−DATASET ACQUISITION TEMPERATURE (EXPRESSION 3)

Next, in the step S605, the candidate dataset is selected based on the calculated reliability evaluation value. More specifically, a dataset having the highest reliability evaluation value is selected as the candidate dataset. In FIG. 7B, dataset No. 10 corresponds.

Next, in the step S606, the vibration detection signal output controller 13 determines whether or not the reliability evaluation value of the candidate dataset is j points or higher. For example, if j=7, the dataset No. 10 is j or higher and thus the flow proceeds to the step S607.

At the step S607, the vibration detection signal output controller 13 reads the offset value contained in the selected candidate datasets (use dataset), and sets it to the use offset value to be subtracted from the vibration detection signal from gyro sensor 3.

Next, in the step S608, the vibration detection signal output controller 13 sets the switch 12 to the subtractor 10 side. Thereby, the offset removed vibration detection signal as a result of a subtraction of the use offset value in the subtractor 10 from the vibration detection signal from the gyro sensor 3 is output to the vibration correction signal generating unit 14 and used to generate the vibration correction signal.

The expressions 1 to 3 are merely illustrative expressions used to calculate the reliability evaluation value, and the reliability evaluation value may be calculated by another expression. For example, the weight of each acquisition condition, such as the date and temperature, may be changed.

If the evaluation value is less than j points in the step S606, the microcomputer 1′ determines that there is no highly reliable offset value this time and proceeds to the step S609.

In the step S609, the microcomputer 1′ waits for c seconds until it is ready to newly obtain the offset value. A period of c seconds is as described in the step S212 in FIG. 2.

Next, in the step S610, the microcomputer 1′ samples the vibration detection signal output from the gyro sensor 3 for d seconds or a predetermined time, and obtains the amplitude of the vibration detection signal during that period.

Next, in the step S611, the microcomputer 1′ determines whether or not the amplitude of the vibration detection signal obtained in the step S610 falls within ±e [deg/sec] or within the predetermined amplitude range. When the amplitude falls within ±e [deg/sec] or it is determined that there is no significant camera vibration, the microcomputer 1′ proceeds to 612 and acquires a new offset value through the offset acquirer 6.

In the step S613, the microcomputer 1′ determines whether the new offset value has been successfully acquired in the step S612. If so, the process proceeds to the step S607 and the new offset value is set to the use offset value. This new offset value is added as a new dataset to the memory 7 with the (current) date temperature and other acquisition conditions when it was acquired.

On the other hand, if it is determined in the step S611 that the amplitude of the vibration detection signal does not fall within ±e [deg/sec] or when it is determined that there is a significant camera vibration, the microcomputer 1′ proceeds to the step S614.

In the step S614, the microcomputer 1′ (vibration detection signal output controller 13) displays on the display unit 23 a message prompting the user to calibrate the offset value of the gyro sensor 3.

Next, in the step S615, when the user instructs the microcomputer 1′ to calibrate the offset value in response to the message, the microcomputer 1′ proceeds to the step S612 and acquires a new offset value through the offset acquirer 6. When the user does not instruct the calibration or when the acquisition of the new offset value has failed in the step S613, the microcomputer 1′ proceeds to the step S616.

In the step S616, the offset remover 9 inputs a vibration detection signal from the gyro sensor 3 to the high-pass filter 11, and performs a high-pass filter calculation on the vibration detection signal.

In the step S617, the vibration detection signal output controller 13 sets the switch 12 to the high-pass filter 11 side. Thereby, the low-cut vibration detection signal in which the offset component is reduced after passing through the high-pass filter 11 is output to the vibration correction signal generating unit 14 and used to generate the vibration correction signal. The cutoff frequency of the high-pass filter 11 is as described in the first embodiment.

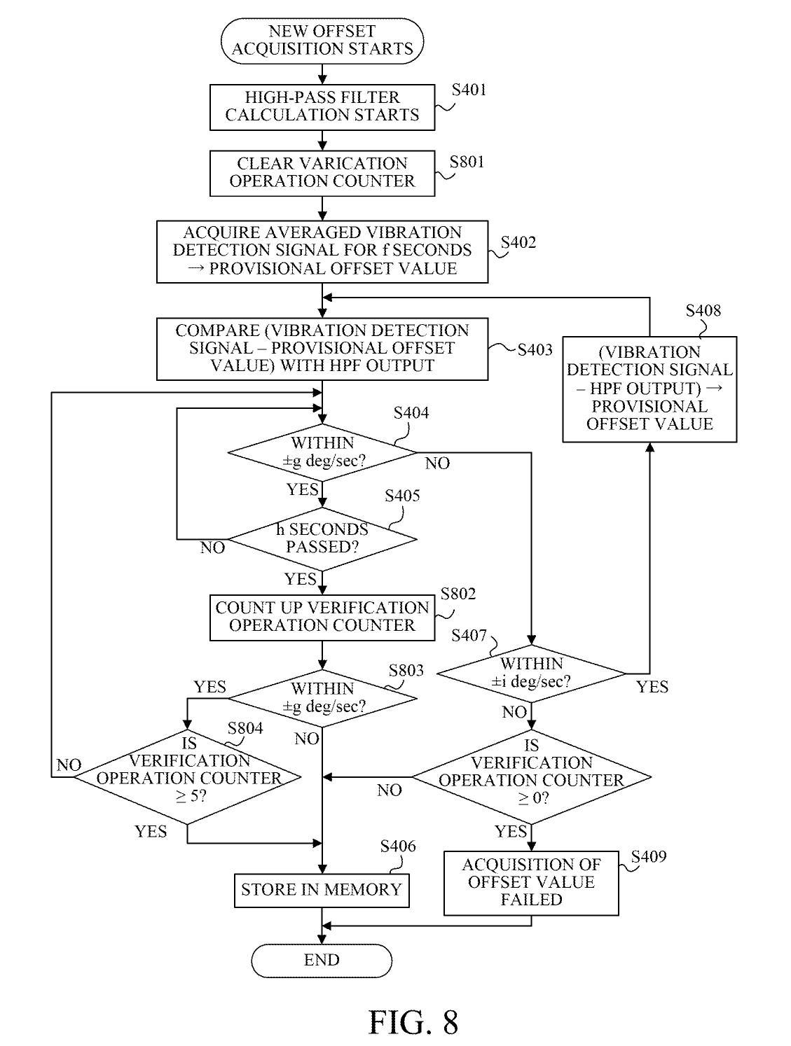

A flowchart in FIG. 8 illustrates processing of acquiring a new offset value performed in the step S612 in FIG. 6. Those steps in FIG. 8, which are corresponding steps in FIG. 4, will be designated by the same step numerals as those in FIG. 4 and only different steps from the flowchart in FIG. 4 will be described.

After starting the high-pass filter calculation for obtaining the offset value in the step S401, the offset acquirer 6 clears the verification operation counter in the step S801 and then performs the processing in the steps S402 to S404.

The microcomputer 1′ proceeds to the step S802 when a difference between the provisional offset removed vibration detection signal (vibration detection signal−provisional offset value) and the new low-cut vibration detection signal falls within ±g [deg/sec] in the step S404 and this state continues for h seconds in the step S405.

In the step S802, the offset acquirer 6 increments the verification operation counter by one. In other words, the verification operation of the acquired offset value is completed once when the state in which the difference falls within ±g [deg/sec] continues for h seconds.

Thereafter, in the step S803, the microcomputer 1′ again determines whether or not the difference falls within ±g [deg/sec], and if so, proceeds to the step S804.

In the step S804, the offset acquirer 6 determines whether or not the verification operation counter indicates 5 or more, or whether or not the verification operation has been completed five times or more. When the verification operation has been completed five times or less, the offset acquirer 6 returns to the steps S404 and S405 so as to performs the verification operation from the beginning, which determines whether or not the state in which the difference between the provisional offset removed vibration detection signal and the new low-cut vibration detection signal falls within ±g [deg/sec] continues for h seconds.

When the verification operation is completed five times or more, the microcomputer 1′ proceeds to the step S406. The microcomputer 1 correlates the date, the temperature, and another acquisition condition acquired by the condition acquirer 5′ and the “new offset value” that is the provisional offset value acquired this time with one another and stores them as one pair of datasets in the memory 7. The other acquisition, as used herein, contains the result of the verification operation.

On the other hand, when the flow proceeds from the step S404 to the step S407 and the microcomputer 1′ determines that the difference between the provisional offset removed vibration detection signal and the new low-cut vibration detection signal is ±i [deg/sec] or more, the flow proceeds to the step S805. This difference becomes ±i [deg/sec] or more when an unfavorable large camera vibration occurs in acquiring the offset value.

In the step S805, the microcomputer 1′ determines whether the verification operation counter indicates 0 or not. If the verification operation counter does not indicate 0, there is an offset value which has already undergone the verification operation at least once before a large camera vibration occurs, so the microcomputer 1′ proceeds to the step S406 and sets the offset value to a “new offset value” and stores it in the memory 7.

On the other hand, when the verification operation counter indicates 0, a highly reliable offset value has not been acquired and thus the microcomputer 1′ proceeds to the step S409, terminating this processing with an unsuccessful acquisition of the offset value.

This embodiment can remove the offset component from the vibration detection signal by using the most reliable offset value among a plurality of offset values previously stored in the memory, and thus enhance the antivibration (image stabilization) control accuracy. Further, even when there are no optimal offset value in the plurality of offset values, this embodiment can perform an appropriate antivibration control to some extent.

A description will now be given of the breakdown (or item) and evaluation example of the other acquisition condition shown in FIG. 7C. There are seven types of other acquisition conditions shown in FIG. 7C, and each is assigned one of 8-bit variables with the same weight. For the other acquisition condition, if the condition is a preferable condition for acquiring the offset value, the corresponding bit (or the evaluation value) becomes 0, and the bit corresponding to the unfavorable condition becomes 1.

The bit 7 represents a magnitude of an angular velocity (vibration detection signal) in acquiring the offset value. The maximum value and the minimum value of the angular velocity are acquired from the output of the gyro sensor 3, and when they fall within the predetermined range, the bit 7 becomes 0, and otherwise the bit 7 becomes 1.

The bit 6 represents whether or not there is a verification operation. When the verification operation could be performed in acquiring the offset value, the bit 6 becomes 0, and otherwise the bit 6 becomes 1.

The bit 5 represents the number of times the verification operation is performed. When the verification operation is performed three times or more, the bit 5 becomes 0, and when the number is less than twice the bit 5 becomes 1.

The bit 4 represents whether or not a motion vector was referred to in obtaining the offset value. The motion vector is detected by the vector detection unit 22 based on an image signal obtained by an output from an unillustrated imaging element. When the detected motion vector has a magnitude close to 0, the camera body 200 is highly likely stationary and thus when it is confirmed that the camera body 200 is stationary based on the motion vector, the bit 4 becomes 0 and otherwise the bit 4 becomes 1.

The bit 3 represents whether the offset value was acquired automatically or in response to an instruction from the user. Where the user performs the calibration according to the display prompting the calibration of the offset value on the display unit 23 described above, the offset value is highly likely acquired in an appropriate situation and the bit 3 becomes 0 and otherwise the bit 3 becomes 1.

The bit 2 represents the orientation of the camera body 200. By an example, assume that the most stable vertical orientation is set to a reference when the camera body 200 is placed on a plane of a desk or the like. When it is confirmed based on the output of the acceleration sensor 19 that the camera body 200 is in the vertical orientation, the bit 2 becomes 0 and otherwise the bit 2 becomes 1 (in case of a horizontal orientation).

The bit 1 represents the location where the offset value was acquired. This embodiment has previously registered locations normally used by the user and detects the position (coordinate) of the camera body 200 when the offset value is acquired, based on the output of the pressure sensor 20 or the GPS sensor 21. Then, when the camera body 200 is in or near a normally used place, the bit 1 becomes 0 and otherwise the bit 1 becomes 1. The bit 0 has a fixed value of 0 because there is no corresponding acquisition condition.

The breakdown of the other acquisition condition described herein is merely illustrative and may be variable according to the characteristics of the gyro sensor 3 and the antivibration system, or another acquisition condition may be set up. The evaluation value of each acquisition condition may be expressed as a variable so as to change the weight of each acquisition condition, as well as being expressed by 0 and 1 as shown in FIG. 7C.

The first and second embodiments use the values of a, b, c, d, e, f, g, h, i, and j for each determination step, but specific examples of these values are as follows: a=30 (days), b=5 (° C.), c=1 (sec), d=0.5 (sec), e=1 (deg/sec), f=0.2 (sec), g=0.5 (deg/sec), h=0.5 (sec), i=5 (deg/sec), and j=7 (points).

While the first and second embodiments store offset values for different acquisition conditions in the memory, and select a candidate offset value and a use offset value from among them. However, the value stored in the memory may not be necessarily the offset value itself, but may be a correction value used to correct the offset component in the vibration detection signal. For example, a coefficient serving as a correction value used to correct the vibration detection signal may be stored in the memory in association with the temperature. Further, the correction value may be any values other than the offset value and the coefficient.

Each embodiment can obtain a more accurate correction value for the vibration detection signal in using the optical apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processing units (e.g., central processing unit (CPU), micro processing unit (MPU)) and may include a network of separate computers or separate processing units to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-168750, filed on Sep. 1, 2017, which is hereby incorporated by reference herein in its entirety.

What is claimed is:

1. A control apparatus for an optical apparatus comprising:
a correction value acquiring unit configured to acquire a correction value used to correct a first vibration detection signal output from a vibration detecting unit configured to detect a vibration of the optical apparatus; and
a processing unit configured to store in a memory a plurality of correction values on different acquisition conditions used to acquire the correction values in such a manner that each of the plurality of correction values is correlated with the acquisition condition on which the each of the plurality of correction values is acquired.

2. The control apparatus according to claim 1, wherein the correction value is used to correct an offset component contained in the first vibration detection signal.

3. The control apparatus according to claim 1, wherein the acquisition condition contains at least one of a temperature, a date, and a location.

4. The control apparatus according to claim 1, further comprising a signal generating unit configured to generate a second vibration detection signal obtained by correcting the first vibration detection signal with the correction value,
wherein the signal generating unit selects a use correction value used to generate the second vibration detection signal from among at least one candidate correction value correlated with the acquisition condition that falls with a predetermined range about a detection condition for the vibration among the acquisition conditions for the plurality of correction values.

5. The control apparatus according to claim 1, further comprising a signal generating unit configured to generate a second vibration detection signal obtained by correcting the first vibration detection signal with the correction value,
wherein the signal generating unit determines a reliability of each of the plurality of correction values by using the acquisition conditions for the plurality of correction values and the detection condition for the vibration, and selects a use correction value used to generate the second vibration detection signal from among the plurality of correction values based on the reliability.

6. The control apparatus according to claim 5, wherein the signal generating unit sets a new correction value as the use correction value, the new correction value being acquired with the first vibration detection signal that falls within a predetermined amplitude range at least for a predetermined time.

7. The control apparatus according to claim 6, wherein the processing unit stores in the memory the new correction value and the acquisition condition in acquiring the new correction value in such a manner that the new correction value and the acquisition condition are correlated with each other.

8. The control apparatus according to claim 6, wherein the signal generating unit outputs information that prompts a user to reacquire the correction value when the candidate correction value or the use correction value does not exist and when the first vibration detection signal does not fall within the predetermined amplitude range for the predetermined time.

9. An optical apparatus comprising:
a control apparatus for an optical apparatus, the control apparatus including a correction value acquiring unit configured to acquire a correction value used to correct a first vibration detection signal output from a vibration detecting unit configured to detect a vibration of the optical apparatus, and a processing unit configured to store in a memory a plurality of correction values on different acquisition conditions used to acquire the correction values in such a manner that each of the plurality of correction values is correlated with the acquisition condition on which the each of the plurality of correction values is acquired; and
at least one of the vibration detecting unit and an antivibration controller configured to control an antivibration operation by using a second vibration detection signal obtained by correcting the first vibration detection signal with the correction value.

10. A control method for an optical apparatus comprising the steps of:
acquiring a correction value used to correct a first vibration detection signal output from a vibration detecting unit configured to detect a vibration of the optical apparatus; and
storing in a memory a plurality of correction values on different acquisition conditions used to acquire the correction values in such a manner that each of the plurality of correction values is correlated with the acquisition condition on which the each of the plurality of correction values is acquired.

11. A storage medium storing a control program that enables a computer in an optical apparatus to execute the steps of:
acquiring a correction value used to correct a first vibration detection signal output from a vibration detecting unit configured to detect a vibration of the optical apparatus; and
storing in a memory a plurality of correction values on different acquisition conditions used to acquire the correction values in such a manner that each of the plurality of correction values is correlated with the acquisition condition on which the each of the plurality of correction values is acquired.
